(19) United States
(12) Patent Application Publication
(10) Pub. No.: US 2016/0314447 A1
(43) Pub. Date: Oct. 27, 2016

(54) CONTROL OF ENTERPRISE LICENSING ACROSS MOBILE DEVICES

(71) Applicant: Kony, Inc., Orlando, FL (US)

(72) Inventors: Matthew B. TREVATHAN, Roswell, GA (US); Keith KATZ, Orlando, FL (US)

(21) Appl. No.: 15/135,662

(22) Filed: Apr. 22, 2016

Related U.S. Application Data
(60) Provisional application No. 62/152,361, filed on Apr. 24, 2015.

(51) Int. Cl. G06Q 20/12; G06F 21/10; G06Q 30/06

(52) U.S. Cl. CPC G06Q 20/1235; G06Q 30/0609; G06F 21/105

(57) ABSTRACT

System and methods of providing enterprise-wide licensing of apps that are deployed to mobile devices within the enterprise are provided. A method includes: make an enterprise app available to targeted users via an enterprise app store; determine a number of consumed licenses equals a maximum number of licenses for the enterprise app; and based on the determining, preventing non-licensed ones of the targeted users from obtaining the enterprise app from the enterprise app store while simultaneously permitting licensed ones of the targeted users to access the enterprise app in the enterprise app store.

### FIELD OF THE INVENTION

The invention relates to control of mobile applications (apps) and, more particularly, to systems and processes which provide enterprise-wide licensing of apps that are deployed to mobile devices within the enterprise.

### BACKGROUND

Mobile applications (apps) are software programs that run on mobile computing devices such as smartphones, tablet computers, laptop computers, etc. An enterprise app is a particular type of app that is privately available and used only within an enterprise/organization, as opposed to publicly available apps that are available to anyone in stores such as the Apple App Store and Google Play. Enterprise apps are typically designed to be used within the organization while meeting strict requirements for security and administration management

It is common to utilize an enterprise app store to catalog, distribute, and manage the apps within an enterprise. It is also common for users within the enterprise to have unlimited access to the enterprise apps that are published in the enterprise app store. Using this model, there is no limit to the number of times that an enterprise app may be downloaded from the enterprise app store. However, as enterprise apps have become more complex, the costs for development and maintenance per enterprise app have increased, such that unlimited distribution of an enterprise app within the enterprise can have disadvantageous cost consequences for the enterprise.

For example, an enterprise may contract with a third party to include the third party's service or library in an enterprise app on a cost per user/device basis. Specifically, the third party may provide code that is used in the enterprise app, and the enterprise may in turn agree to pay the third party a fixed fee for each deployment of the enterprise app. The result is that even though the enterprise app is owned by the enterprise and is only distributed internally within the enterprise, there is a real cost to the enterprise for each deployment of the enterprise app.

In another example, an enterprise may contract with a third party to include the third party's service or library in an enterprise app on fixed number of devices. Specifically, the third party may provide code that is used in the enterprise app, and the enterprise may purchase a specific number of licenses from the third party, thereby contractually defining a maximum number of devices to which the enterprise app may be deployed. Unlimited distribution of the enterprise app within the enterprise could result in violation of the contractual agreement.

Moreover, many large enterprises are distributed internal department models in which each department is responsible for its own profit and loss tracking. A particular department that pays to develop an enterprise app may bear a disproportionate amount of the overall cost of the app when users from other departments have unlimited access to the app. In this case, the department that invests the funding toward developing and maintaining the enterprise app may wish to assign intra-enterprise costs to other departments that utilize the app.

### SUMMARY

In a first aspect of the invention there is a method implemented in a computer infrastructure having computer executable code tangibly embodied on a computer readable storage medium having programming instructions operable to: make an enterprise app available to targeted users via an enterprise app store; determine a number of consumed licenses equals a maximum number of licenses for the enterprise app; and based on the determining, preventing non-licensed ones of the targeted users from obtaining the enterprise app from the enterprise app store while simultaneously permitting licensed ones of the targeted users to access the enterprise app in the enterprise app store.

In a another aspect of the invention there is a computer program product comprising a computer readable storage medium having program instructions embodied therewith, the program instructions being executable by a server to cause the server to: publish an enterprise app to an enterprise app store such that it is available for download by targeted users; receive a request from a mobile device to run the enterprise app; determine whether a number of consumed licenses of the enterprise app is less than a maximum number of licenses of the enterprise app; and based on the determining, perform one of: permit the mobile device to run the enterprise app when the number of consumed licenses is less than the maximum number of licenses; and prevent the mobile device from running the enterprise app when the number of consumed licenses is not less than the maximum number of licenses.

In a another aspect of the invention there is a system, comprising: a CPU, a computer readable memory and a computer readable storage medium; program instructions to cause a server to receive a request from an agent on a mobile device to run a enterprise app; and program instructions to cause the server to send instruction to the agent to one of: permit the mobile device to run the enterprise app when a number of consumed licenses of the enterprise app is less than a maximum number of licenses of the enterprise app; and prevent the mobile device from running the enterprise app when the number of consumed licenses is not less than the maximum number of licenses. The program instructions are stored on the computer readable storage medium for execution by the CPU via the computer readable memory.

### BRIEF DESCRIPTION OF DRAWINGS

FIG. 1 shows an illustrative environment for managing the processes in accordance with the invention.

FIG. 2 shows an exemplary cloud computing environment in accordance with aspects of the invention.

FIG. 3 shows an illustrative system for managing the processes in accordance with the invention.

FIGS. 4 and 5 show exemplary user interfaces in accordance with aspects of the invention.

FIGS. 6A-D show an exemplary implementation of aspects of the invention.

FIG. 7 shows an illustrative system for managing the processes in accordance with the invention.

FIGS. 8 and 9 show flowcharts of exemplary methods in accordance with aspects of the invention.

### DETAILED DESCRIPTION

The invention relates to control of mobile applications (apps) and, more particularly, to systems and processes which provide enterprise-wide licensing of apps that are deployed to mobile devices within the enterprise. According to aspects of the invention, an enterprise system monitors and controls a number of deployments or concurrent uses of an enterprise app based on a pre-defined maximum number of intra-enterprise licenses for the particular enterprise app. In embodiments, the enterprise system leverages mobile application management (MAM) techniques to prevent a mobile device from downloading or running the enterprise app without a license. In this manner, implementations of the invention provide a license-based mechanism to control enterprise app usage within an enterprise.

### System Environment

The present invention may be embodied as a system, method or computer program product. The present invention may take the form of a hardware embodiment, a software embodiment or a combination of software and hardware. Furthermore, the present invention may take the form of a computer program product embodied in any tangible storage medium of expression having computer-usable program code embodied in computer readable storage medium.

The computer readable storage medium is not a transitory signal per se, and is any tangible medium that can contain and store the program for use by or in connection with an instruction execution system, apparatus, or device. For example, the computer readable storage medium can comprise electronic, magnetic, optical, electromagnetic, infrared, and/or semiconductor systems and/or devices. More specific examples (a non-exhaustive list) of the computer readable storage medium include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer readable storage medium may be any tangible medium that can contain or store a program for use by or in connection with an instruction execution system, apparatus, or device of the present invention.

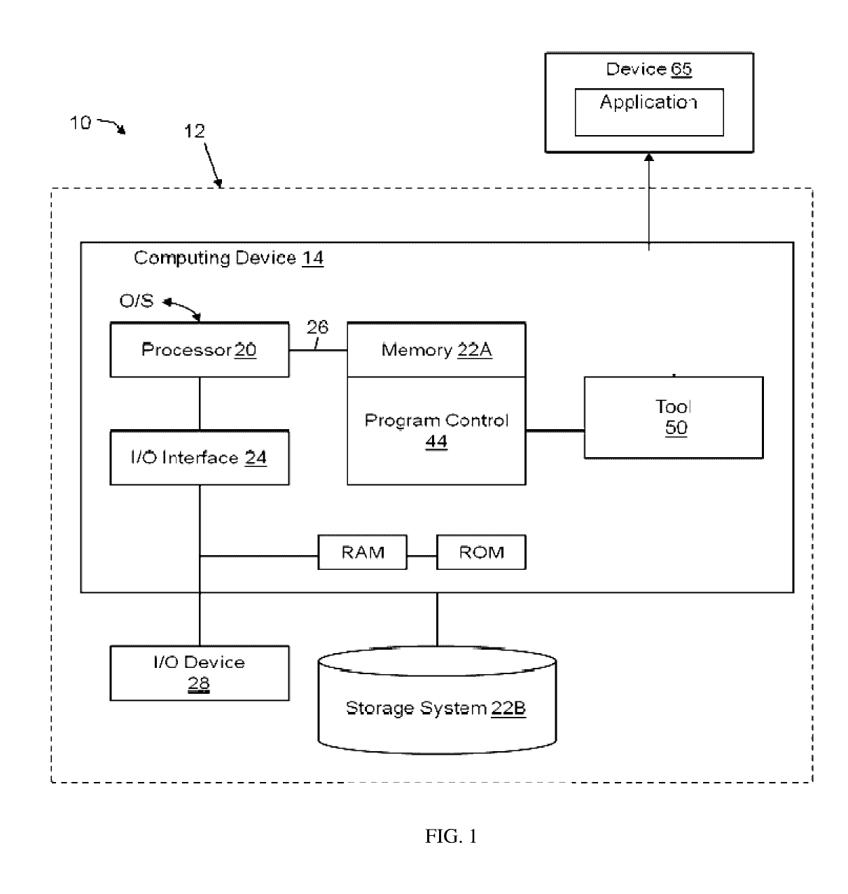

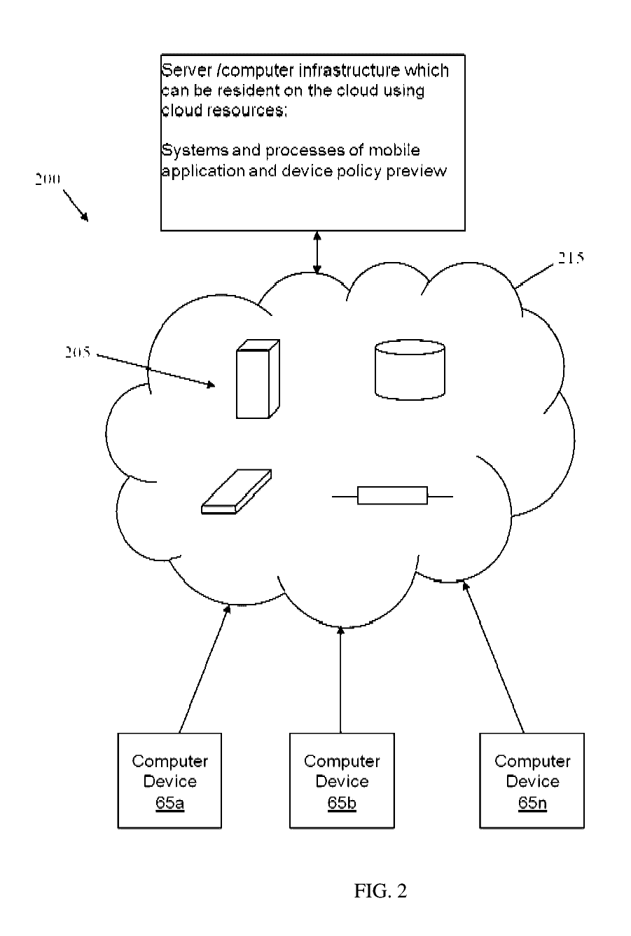

FIG. 1 shows an illustrative environment 10 for managing the processes in accordance with the invention. The environment 10 includes a server 12 or other computing system. The server 12 can be a standalone server, which implements the processes described herein within a networking environment. The server 12 and/or processes performed by the server 12 can be integrated into the networking environment (e.g., cloud environment) such as shown in FIG. 2 or any enterprise management system as described herein.

In somer embodiments, the server 12 can be representative of a mobile backend as a service (MBaaS), maintained by a service provider, e.g., Kony™. As should be understood by those of ordinary skill in the art, the MbaaS is a model for providing web and mobile application developers with a way to link their applications to backend cloud storage and APIs exposed by backend applications, while providing features such as user management, push notifications, and integration.

In embodiments, the server 12 can also be representative of other types of business enterprise servers, accessible via cloud based applications. For example, the server 12 can be a single, open standards-based mobile infrastructure platform. In embodiments, the single, open standards-based mobile infrastructure platform can unify multiple infrastructures/platforms together, including mobile application development platform (MADP), mobile backend as a service (MBaaS), Application Programming Interface (API) management, and platform as-a-service (PaaS) infrastructures. To this end, for example, the server 12 can be representative of Kony™ MobileFabric™ which is a converged mobile infrastructure that empowers enterprises to significantly reduce time to market. In this example, the server 12 can further integrate EMM/MAM server functions (e.g., management instances), as well as incorporate any number of enterprise stores. For example, the server 12 can maintain an enterprise app store and apply mobile application management (MAM) techniques to enterprise apps made available in the enterprise app store.

In embodiments, the server 12 communicates with one or more computer device(s) 65 via a computer network. The computer device(s) 65 can be, for example, a smartphone, tablet computer, laptop computer, personal digital assistant, or similar computing device that includes a mobile operating system, wireless communication antenna, processor, user interface, memory, etc. In an enterprise setting, the server 12 may be an enterprise server, and the devices 65 may download apps directly from an enterprise app store maintained by the server 12.

The server 12 includes a computing device 14 which can be resident on a network infrastructure or computing device. The computing device 14 includes a processor 20 (e.g., a CPU), a memory 22A, an I/O interface 24, and a bus 26. The bus 26 provides a communications link between each of the components in the computing device 14. In addition, the computing device 14 includes a random access memory (RAM), a read-only memory (ROM), and an operating system (O/S). The computing device 14 is in communication with the external I/O device/resource 28 and a storage system 22B. The I/O device 28 can comprise any device that enables an individual to interact with the computing device 14 (e.g., user interface) or any device that enables the computing device 14 to communicate with one or more other computing devices (e.g., devices 65, etc.) using any type of communications link.

The processor 20 executes computer program code (e.g., program control 44), which can be stored in the memory 22A and/or storage system 22B. In embodiments, the program control 44 of the computing device 14 of the server 12 controls the tool(s) 50 described herein which can be program modules, etc., comprising program code adapted to perform one or more of the processes described herein. The tool(s) 50 can be implemented as one or more program code in the program control 44 stored in memory 22A as separate or combined modules. Additionally or alternatively, the tool(s) 50 may be implemented as separate dedicated special use processors or a single or several processors to provide the functionality described herein. While executing the computer program code, the processor 20 can read and/or write data to/from memory 22A, storage system 22B, and/or I/O interface 24. In this manner, the program code executes the processes of the invention.

The program code can include computer program instructions stored in a computer readable storage medium. The computer program instructions may also be loaded onto the computer 14, other programmable data processing apparatus, or other devices to cause a series of operational steps to be performed on the computer. Moreover, any methods provided herein in the form of flowcharts, block diagrams or otherwise may be implemented using the computer program instructions, implemented on the computer readable storage medium.

In embodiments, the server 12 is an enterprise mobility management (EMM) server that is configured to perform mobile device management (MDM) and mobile application management (MAM) functions. The tool(s) 50 may comprise an MDM module that enables the server 12 to manage devices 65 that are registered with the server 12. A purpose of MDM is to ensure that all the devices and device users are in compliance with the IT policies set by organization. In an MDM-based system, an agent (e.g., a software program) resides on each mobile device (e.g., device 65) and communicates with the MDM module of the EMM server (e.g., server 12). In an MDM-based system, the operating system (OS) of the mobile device is programmed to permit the MDM module of the server, via the agent, to cause the operating system of the mobile device to perform certain functions, such as: implement device policies and set automated, rule-based actions for policy violations; restrict usage of device features (e.g., camera, microphone, etc.); and locate, lock, wipe or reset any enrolled device. The agent interacts with the OS of the mobile device via application program interfaces (APIs) and appropriate programming.

The tool(s) 50 may comprise an MAM module that enables the server 12 to control certain aspects of enterprise apps on mobile devices 65 that are registered with the server 12. The MAM module may operate an enterprise app store to distribute private (enterprise) apps and public (non-enterprise) apps to mobile devices 65 within the enterprise. The MAM module may, for example, restrict enterprise app usage on mobile devices 65 based on idle timeout, geo-fencing, and other parameters. The MAM module may also, for example, lock, wipe, erase and expire enterprise apps on a mobile device 65. MAM functions may be implemented using the agent that resides on the mobile device 65, wherein the agent communicates with the MAM module and interacts with the OS of the device via APIs. In implementations of the invention, the server 12 can perform MAM functions such as: sending a command to an agent on a mobile device 65 to remotely uninstall a particular enterprise app from the mobile device 65; and sending a command to an agent on the mobile device 65 to prevent the mobile device 65 from opening/running the enterprise app.

According to aspects of the invention, the tool(s) 50 allow an administrator define a maximum number of licenses for each enterprise app contained in an enterprise app store. The tool(s) 50 monitor the number of deployments of the enterprise app from the enterprise app store, with each deployment counting as one license of the enterprise app. A deployment may be, for example, a download and install of the enterprise app on a device 65 from an enterprise app store maintained by the server 12. When the number of licenses of the enterprise app equals the maximum number of licenses, the tool(s) 50 automatically modify the enterprise app store to prevent any more deployments of the enterprise app. In this manner, the server 12 limits the number of deployments of the enterprise app to not exceed the pre-defined maximum number of licenses.

In one embodiment, when the number of licenses equals the maximum number of licenses, the tool(s) 50 control the enterprise app store so that users who do not have a license cannot see an icon for the enterprise app in a display of the enterprise app store on their device. In another embodiment, when the number of licenses equals the maximum number of licenses, the tool(s) 50 modify the icon of the enterprise app in the enterprise app store so that users who do not have a license can see the enterprise app exists but that it is currently unavailable for them to download from the enterprise app store. In both embodiments, when the number of licenses equals the maximum number of licenses, users who do have a license can see the enterprise app in the enterprise app store in a normal manner, e.g., to facilitate updates of the enterprise app.

In one embodiment, the enterprise app is available to any targeted user in the enterprise on a first-come, first-served basis until the maximum number of licenses of the enterprise app is reached. In another embodiment, a first subset of the maximum number of licenses is reserved and a second subset of the maximum number of licenses is available on a first-come, first-served basis. The licenses in the first subset may be reserved for a particular device, user, or group of users, e.g., as defined by an enterprise admin via an interface with the server 12.

According to aspects of the invention, the tool(s) 50 are configured with the ability to revoke a license (or licenses) from a particular device 65, user, or group of users. For example, when the number of licenses equals the maximum number of licenses, the tool(s) 50 may revoke a license from one user and then provide that license to another user. Revoking may include, for example, force uninstalling the enterprise app from a user's mobile device 65. The uninstalling may be initiated and forced by the tool(s) 50 using MAM techniques, e.g., using an MAM/MDM agent on the mobile device. In this manner, implementations of the invention may accommodate an urgent request for the enterprise app from an unlicensed user.

In accordance with another aspect of the invention, the tool(s) 50 monitor a number of concurrent uses (active sessions) of the enterprise app, with each concurrent use counting as one license of the enterprise app. The tool(s) 50 receive a request from a mobile device when the enterprise app is invoked on one of the devices 65. The tool(s) 50 monitor a number of used licenses (e.g., concurrently open sessions of the app) and either: permit the device 65 to open the enterprise app when the number of used licenses is less than a maximum number of licenses, or deny the device 65 permission to open the enterprise app when the number of used licenses is equal to the maximum number of licenses. In this manner, the server 12 limits the number of concurrent uses of the enterprise app to not exceed the pre-defined maximum number of licenses. This implementation may include providing a priority mechanism for determining application licensing on devices 65 that allows, e.g., (i) a license to be revoked from running users, (ii) the purchase of a temporary one time use license for a session, or (iii) time limit allowing the user to run the application if no licenses are available. The systems and processes described herein are unique because per-use license offers are not offered on mobile applications today that incorporate the reserve and overflow licensing rules.

FIG. 2 shows an exemplary cloud computing environment 200. Cloud computing is a computing model that enables convenient, on-demand network access to a shared pool of configurable computing resources, e.g., networks, servers, processing, storage, apps, and services, that can be provisioned and released rapidly, dynamically, and with minimal management efforts and/or interaction with a service provider. In embodiments, one or more aspects, functions and/or processes described herein may be performed and/or provided via cloud computing environment 200, e.g., intra-enterprise licensing of enterprise apps, as described herein.

As depicted in FIG. 2, cloud computing environment 200 includes cloud resources 205 that are made available to client devices 65a . . . n via a network 215, such as the Internet. Client devices 65a . . . n may be similar to device 65 of FIG. 1, and may comprise any suitable type of network-enabled computing device, such as handheld computers (e.g., smartphone, tablet computer, laptop computer, personal digital assistant, etc.).

Cloud resources 205 can include a variety of hardware and/or software computing resources, such as servers, databases, storage, networks, applications, and platforms as shown, for example, in the combination of FIGS. 1 and 2. Cloud resources 205 may be on a single network or a distributed network across multiple cloud computing systems and/or individual network enabled computing devices. Cloud resources 205 are typically provided and maintained by a service provider so that a client does not need to maintain resources. In embodiments, cloud resources 205 may include at least one server 12 of FIG. 1 that is specifically adapted to perform one or more of the functions and/or processes described herein.

Cloud computing environment 200 may be configured such that cloud resources 205 provide apps to client devices 65a . . . n, or other computing devices through a variety of service models, such as any combination of Software as a Service (SaaS), Platforms as a service (PaaS), Infrastructure as a Service (IaaS), and/or any other cloud service models. Cloud resources 205 may be configured, in some cases, to provide multiple service models to client devices 65a . . . n, as described herein. Cloud computing environment 200 may be configured such that cloud resources 205 provide computing resources to client devices 65a . . . n, through a variety of deployment models, such as any combination of public, private, community, hybrid, and/or any other cloud deployment model.

One or more cloud resources 205 may be structured in multiple layers or functional abstraction layers, e.g., a firmware and hardware layer, a kernel layer, an infrastructure service layer, a platform service layer, and an application service layer. The firmware and hardware layer may include generic contributing nodes (e.g., data centers, computers, and storage devices) geographically distributed across the Internet and provide the physical resources for implementing the upper layers of the cloud service provider. The kernel layer may include an operating system and/or virtual machine manager that host the cloud infrastructure services. The kernel layer may control and communicate with the underlying firmware and hardware layer through one or more hardware/firmware-level application programming interfaces (APIs). The infrastructure service layer may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer may include platforms and application frameworks that provide platform services, such as an environment for running virtual machines or a framework for developing and launching a particular type of software application. The application service layer may include a software application installed on one or more virtual machines or deployed in an application framework in the platform service layer. The software application can also communicate with one or more infrastructure service components (e.g., firewalls, databases, web servers, etc.) in the infrastructure service layer.

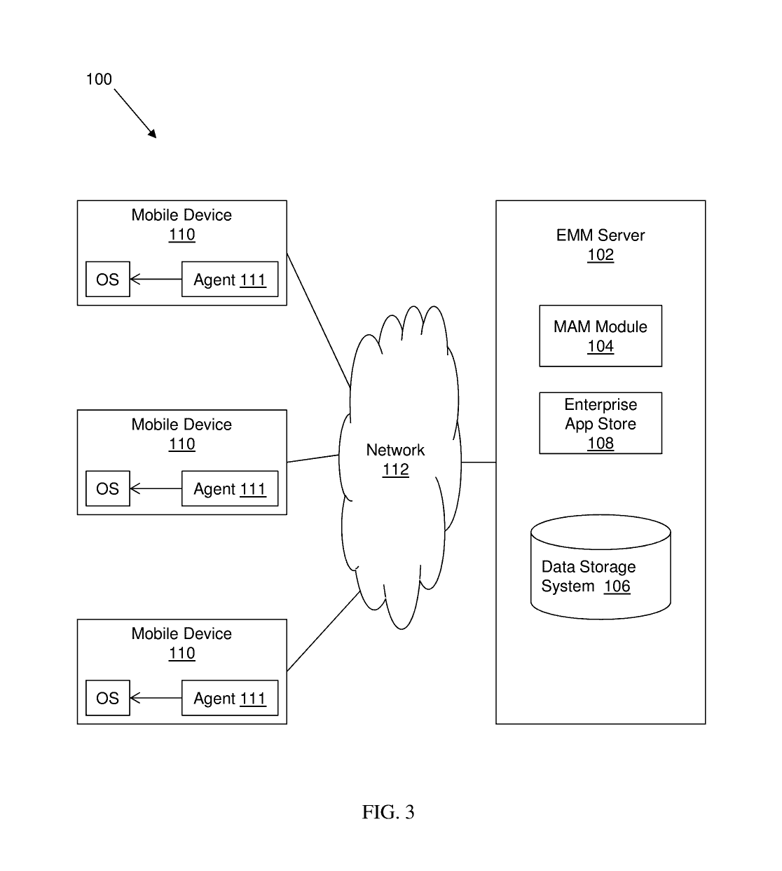

FIG. 3 shows an illustrative system 100 for managing processes in accordance with the invention. As discussed below, FIG. 3 can also be representative of a flow diagram and/or processes of the invention. In embodiments, the system 100 includes an EMM server 102 comprising an MAM module 104 and data storage system 106. The EMM server 102, the MAM module 104, and the data storage system 106 may be similar to server 12, tool(s) 50, and storage system 22B, respectively, of FIG. 1. The EMM server 102 hosts an enterprise app store 108 that is accessible by any desired number of enterprise devices 110 via a network 112. The EMM server 102 may also comprise at least one of an MDM module and an MCM module, although such modules are not the subject of the present disclosure.

With continued reference to FIG. 3, each of the devices 110 may be similar to device 65 of FIG. 1. In embodiments, each device 110 includes an agent 111 (e.g., a software module) that receives MAM instructions from the MAM module 104, sends data to the MAM module 104, and that causes the OS of the device 110 to perform MAM actions (e.g., do not open an app, uninstall an app from the device, etc.) in accordance with instructions and/or policies received from the MAM module 104.

In embodiments, the data storage system 106 stores a catalog of apps that are included in the enterprise app store 108. These may include public (non-enterprise) apps and private (enterprise) apps. An admin (e.g., system administrator) of the enterprise may access the MAM module 104 via a computer-based interface to selectively define properties of apps that are stored in the app store catalog in the storage system 106. For each respective app these properties may include, but are not limited to: whether the app is published or unpublished in the app store 108; targeting of the app; and a maximum number of licenses for the app. As described in greater detail herein, the maximum number of licenses for the app may be used by the MAM module in limiting distribution or concurrent use of an enterprise app amongst devices 110 that are registered with the enterprise.

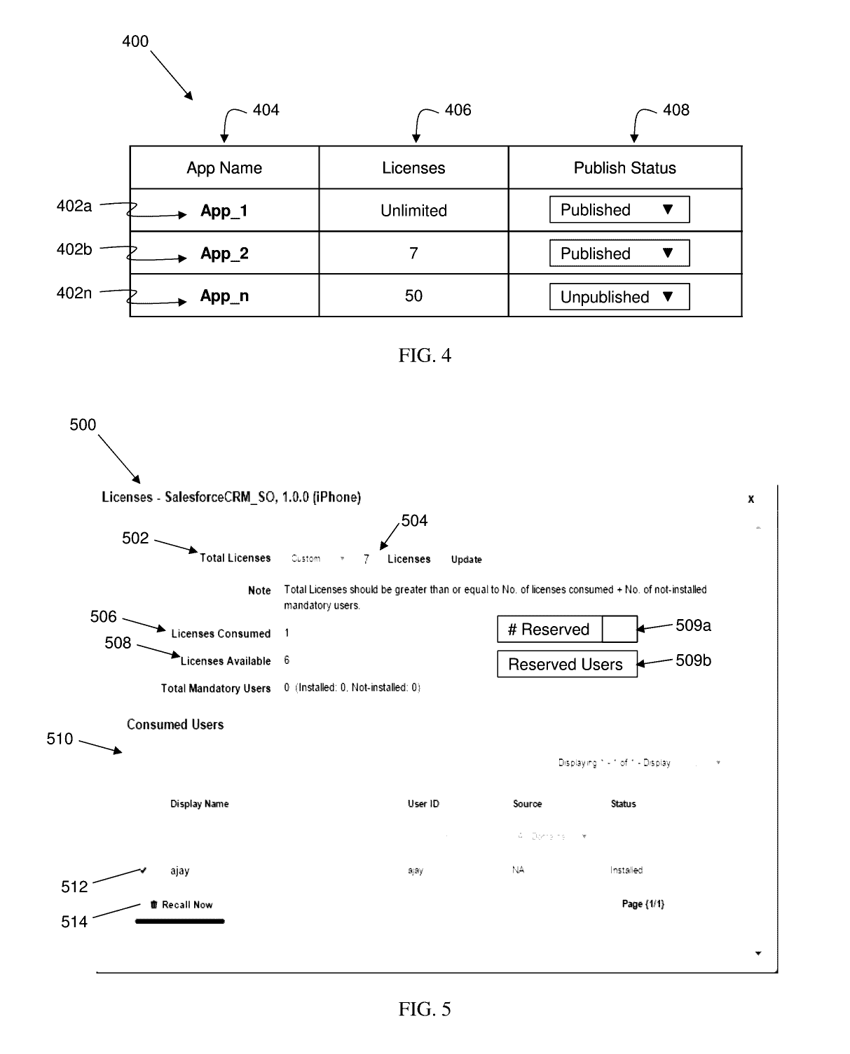

FIG. 4 shows an exemplary computer-based user interface (UI) 400 that is presented by the EMM server 102. The UI 400 lists enterprise apps 402a-n stored in the app store catalog in the storage system 106. For each enterprise app 402a-n, the UI 400 indicates the app name (column 404), a user-defined maximum number of licenses for the app (column 406), and a publish status of the app (column 408). Other columns may be present in the UI 400 but are not pertinent to the present description.

The publish status of an app, as shown at column 408, indicates whether the particular app is published in the enterprise app store 108. A published app is viewable by devices 110 in the enterprise app store 108, whereas an unpublished app is not viewable by devices 110 in the enterprise app store 108. An enterprise admin may publish an app to the app store 108 or unpublish an app from the app store 108 by providing input to column 406 of the UI 400. For example, the admin may change this status to publish or unpublish by double clicking on the column 406 for a respective app and making an appropriate selection.

Another property that can be defined for each respective enterprise app 402a-n via the UI 400 is a target. Targeting defines which users can see an enterprise app in the enterprise app store 108 via their respective devices 110. Only targeted users for a particular enterprise app are shown the enterprise app when they access the enterprise app store via their device 110, whereas non-targeted user are not shown the enterprise app when they access the enterprise app store via their device 110. An enterprise app can be targeted to individual users or groups of users associated with domains. Different enterprise apps can have different targets, as defined by the enterprise admin via input to the MAM module 104. An enterprise admin may define targets for a particular app (e.g., 402a) by selecting the app (e.g., double clicking on the app name in column 404), which causes the system to navigate to a different UI that permits the admin to select individual users or groups of users to be targets of the app.

According to aspects of the invention, another property that can be defined for each respective app 402a-n via the UI 400 is a maximum number of licenses. In embodiments, selecting (e.g., mouse clicking or double clicking) a particular field in column 406 causes the system to navigate to a licensing UI for the app associated with the selected field.

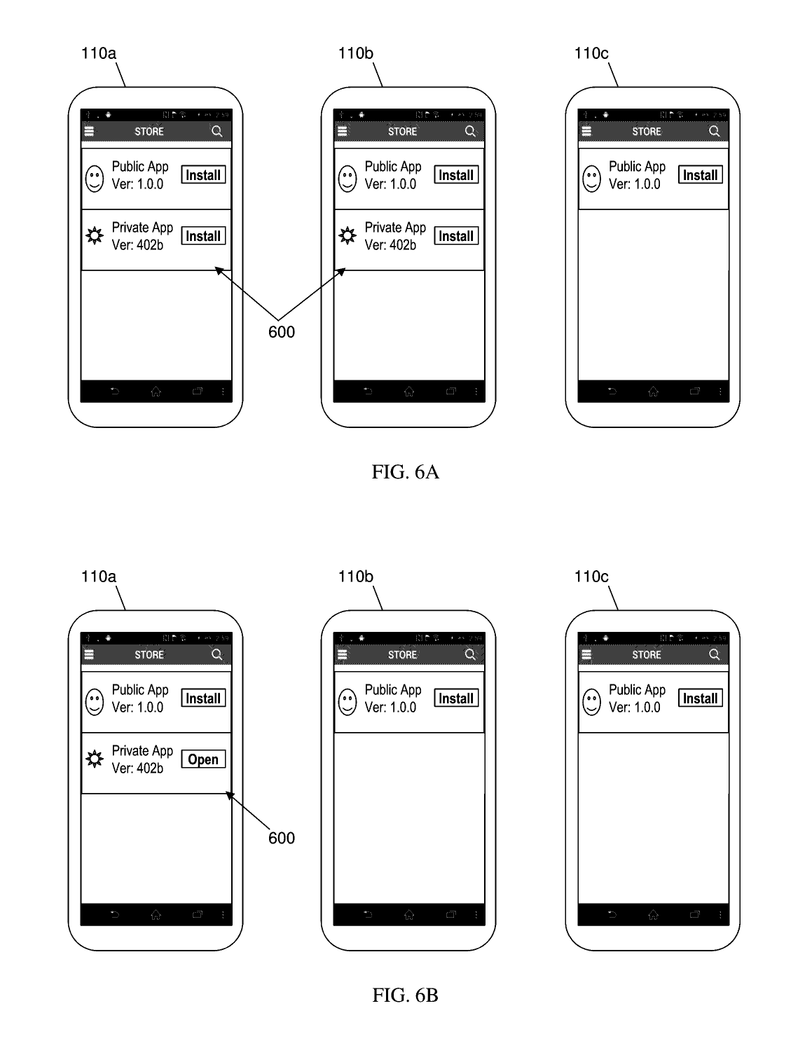

FIG. 5 shows an exemplary licensing UI 500 in accordance with aspects of the invention. In the example shown in FIG. 5, the UI 500 shows the licensing data for app 402b based on the admin selecting the field associated with app 402b in column 406 in the UI 400 of FIG. 4.

In embodiments, the UI 500 includes a selectable field 502 by which the admin can provide input to the system to define a maximum number of licenses for the enterprise app (e.g., app 402b in this example). The field 502 may comprise a drop down menu with selections such as “Unlimited”, “Custom”, and any desired integer greater than zero. “Unlimited” indicates that the maximum number of licenses for the app is essentially infinity, although for practical purposes the system defines the maximum number of licenses as a sufficiently high number that is reasonably expected to never be equaled by the number of distributions or concurrent uses of the app within the enterprise (e.g., one trillion or greater). “Custom” indicates that the admin can specify an exact number for the maximum number of licenses for the app. In the example, shown in FIG. 5, the admin has selected “Custom” at field 502 and input a value “7” at field 504, meaning that the maximum number of licenses for app 402b is seven. In addition to “Unlimited” and “Custom” the system may be programmed to display any desired numbers as selections as field 502, e.g., 10, 50, 100, etc.

In embodiments, the UI 500 includes an indication of the number of licenses consumed (e.g., used) at field 506 and the number of licenses available at field 508. In one embodiment, the number of licenses consumed equals the number of installs of the app (e.g., app 402b) on the various devices 110, and the number of licenses available equals the maximum number of licenses (field 502) less the number of licenses consumed (field 506). In another embodiment, the number of licenses consumed equals the number instances of the app currently running (active sessions of the app) across all devices 110. In the example, shown in FIG. 5, currently only one enterprise has the app 402b installed on their device 110, such that the number of licenses consumed equals “1” and the number of licenses available equals “6” (i.e., 7 less 1). As described in greater detail herein, the MAM module 104 of FIG. 3 monitors when each app is installed and uninstalled from any device 110, and keeps a running count of the current number of installs of the each enterprise app. The number of licenses consumed at field 506 corresponds to the current number of installs for a particular app.

In embodiments, the UI 500 may also include a field 509a by which the admin can provide input to designate a number of reserved licenses and a field 509b by which the admin may provide input to designate one or more devices, users, or groups of users associated with the number of reserved licenses. Designating a number of reserved licenses provides a mechanism to ensure that certain users are provided with a license to the app 402b. The number of reserved licenses is a user defined number that is less than or equal to the maximum number of licenses defined at field 502. The one or more devices, users, or groups of users associated with the reserved licenses are a subset of the targeted users or group for the app, and may be defined by providing input similar to that for targeting the app. The number of reserved licenses may be defined as equal to a number of devices or a number of users of the one or more devices, users, or groups of users associated with the reserved licenses. In this manner, these devices or users are ensured of having a license of the app 402b. When a number of reserve licenses is specified, the remaining non-reserved licenses (i.e., the maximum number of licenses less the number of reserve licenses) are made available to any targeted user of the app 402b on a first-come, first-served basis in the manner described herein.

Still referring to FIG. 5, in embodiments the UI 500 includes a listing 510 of each currently installed instance of the enterprise app associated with a user of one or more of the devices 110. In other embodiments, the listing 510 shows an entry for each currently running instance (active session) of the app on all devices in the system. The listing 510 may show, for example, a Display Name, User ID, Source, and Status for each currently installed instance of the enterprise app. The example shown in FIG. 5 indicates that user “ajay” has one instance of the app installed, e.g., on one of the devices 110. When there are plural users with the app currently installed on their devices 110 (e.g., the number of licenses consumed indicated at field 506 is greater than one), the listing 510 shows a separate line for each user. The listing 510 may also be configured to show device ID of each device 110 on which the app is installed to increase the level of granularity that is viewable and controllable by the admin at the UI 500.

With continued reference to FIG. 5, according to aspects of the invention, the admin may provide input to the UI 500 that causes the MAM module 104 to revoke the license of the app from any user (or device) shown in the listing 510. For example, the admin may select a particular user (or device) in the listing via a selectable field 512, and then select a recall field 514. Based on receiving such input via the UI 500, the MAM module 104 sends an instruction to the agent 111 residing on the corresponding device 110, wherein the instruction causes the agent 111 to interact with the OS of the device 110 to cause the OS to uninstall the app from the device 110. Upon successful uninstall of the app from the device 100, the agent 111 on the particular device 110 sends a message to the MAM module 104 indicating the name of the app, the ID of the user or device 110, and that the app has been uninstalled. Upon receipt of this message from the agent, the MAM module 104 decrements the number of licenses consumed (e.g., at field 506) and increments the number licenses available (e.g., at field 508) for the particular app.

In accordance with aspects of the invention, when the number of licenses consumed equals the maximum number of licenses for an enterprise app, the MAM module 104 automatically controls the app store 108 to prevent the app from being be downloaded to any additional devices 110 that do not already have a license for the app. In embodiments, when the number of licenses consumed equals the maximum number of licenses for an enterprise app, the system determines a subset of users that are targeted but do not possess a license (do not have the app installed on their device). This subset of users may be determined automatically by the system based on knowledge of the entire pool targeted users minus the licensed users (i.e., those targeted users that currently have the app on their device).

In a first example of preventing distribution of the enterprise app when the number of licenses consumed equals the maximum number of licenses for the enterprise app, the system may automatically de-target the determined subset of users that are targeted for the app but that do not currently have a license. By de-targeting these users, the system makes it so that these users can no longer see the app in the app store. In this example, when one or more licenses subsequently become available, the de-targeted users are then automatically re-targeted by the system so that they can see the app in the app store.

In a second example of preventing distribution of the enterprise app when the number of licenses consumed equals the maximum number of licenses for the enterprise app, the system maintains the determined subset of users as targeted, but automatically causes their device to display a modified icon of the app in the app store. The modified icon shows these users that the app is in the app store, but that it is currently not available for download. In this example, when one or more licenses subsequently become available, the modified icon is replaced with the normal icon of the app in the app store, so that the determined subset of users can once again obtain the app via the app store.

In both examples, when the number of licenses consumed equals the maximum number of licenses for an enterprise app, licensed users (i.e., targeted users that currently have the app installed on their device) can always see the app in the app store, and initially non-targeted users (i.e., users that were not targeted for the app in the first place) never see the app in the app store. In this manner, implementations of the invention control the distribution of an enterprise app within an enterprise to not exceed a user-defined maximum number of licenses.

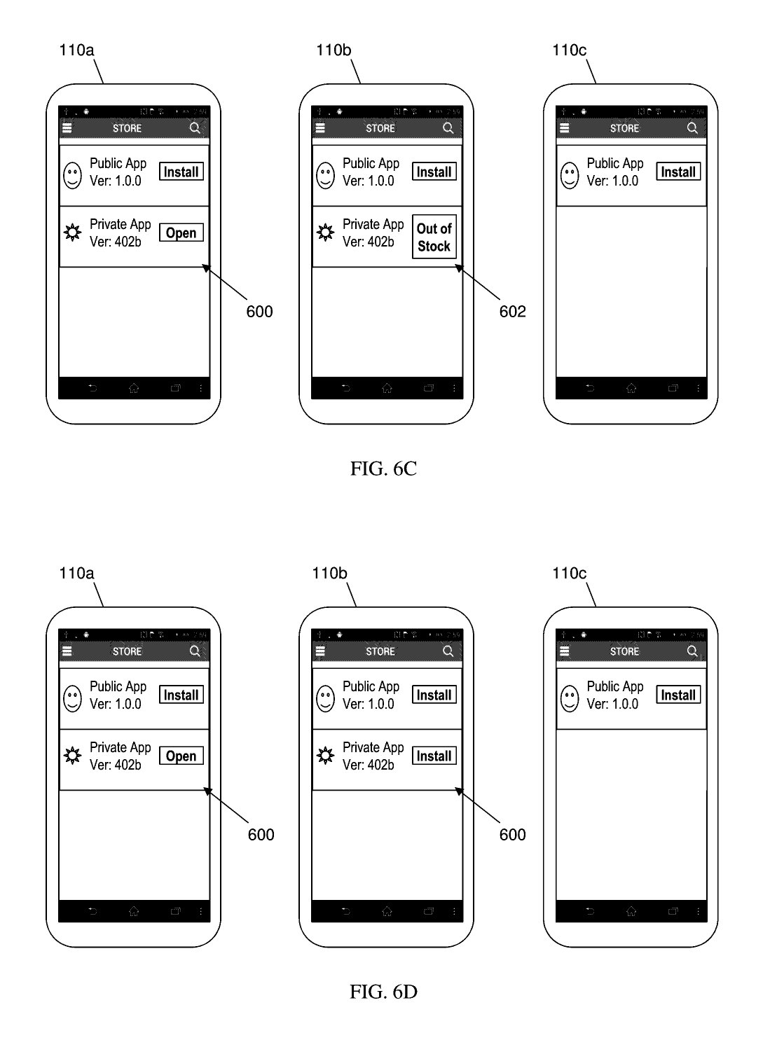

The MAM module 104 controlling of the app store 108 based on maximum license number is demonstrated in FIGS. 6A-D, which show exemplary screen shots of exemplary devices 110a-c of system 100. In the example illustrated in FIGS. 6A-D, the maximum number of licenses for app 402b is seven, devices 110a and 110b are targeted for app 402b, and device 110c is not targeted for app 402b, all of which may be defined by an enterprise admin providing input to UI 400 and UI 500 as described herein. At the time illustrated in FIG. 6A, the number of consumed licenses of app 402b is six, e.g., by devices not shown. Still referring to FIG. 6A, devices 110a and 110b do not have app 402b installed, and each displays an icon 600 of the app 402b as available in the app store (e.g., enterprise app store 108) since these devices are targeted and the number of available licenses is greater than zero, i.e., the number of consumed licenses (6) is less than the maximum number of licenses (7). With continued reference to FIG. 6A, device 110c does not display an icon of the app 402b in the app store, despite the number of available licenses being greater than zero, because device 110c is not targeted for this particular app.

Continuing the example with reference to FIGS. 6B and 6C, device 110a installs the app 402b from the app store, the agent 111 on device 110a sends a message to the MAM module 104 indicating the install of the app 402b, and the MAM module 104 increments the number of consumed licenses of the app 402b from six to seven. With the number of available licenses now being zero, i.e., the number of consumed licenses (7) equals the maximum number of licenses (7), the MAM module 104 automatically controls the app store so that the app 402b is no longer available to other targeted devices, such as device 110b, that do not already have a license for the app 402b. In one embodiment illustrated in FIG. 6B, the MAM module 104 performs such control of the app store by causing the device 110b to not show the icon 600 for the app 402b in the display of the app store. In another embodiment illustrated in FIG. 6C, the MAM module 104 performs such control of the app store by causing the device 110b to show a modified icon 602 of the app 402b in the display of the app store, where the modified icon 602 indicates that the app 402b is published in the app store but currently not available for download (e.g., out of stock). In both embodiments, e.g., FIGS. 6B and 6C, device 110a still displays the icon 600 of the app 402b in the app store because device 110a possesses one of the consumed licenses for the app 402b. In this manner, the user of device 110a can obtain updates of the app 402b via the app store.

Continuing the example with reference to FIG. 6D, another device (not shown) uninstalls the app 402b, the agent on the other device sends a message to the MAM module 104 indicating the uninstall of the app 402b, and the MAM module 104 decrements the number of consumed licenses of the app 402b from seven to six. The uninstall may be a voluntary uninstall initiated by the user of the not shown device, or may be a forced uninstall initiated by the admin using UI 500. In either event, with the number of available licenses now being greater than zero, i.e., the number of consumed licenses (6) being less than the maximum number of licenses (7), the MAM module 104 automatically controls the app store so that the app 402b is again available to targeted devices that do not have a license for the app 402b, such as device 110b. For example, as shown in FIG. 6D, the device 110b shows an icon of the app 402b as available for download from the app store.

In an exemplary use case of the system and method of FIGS. 3-5, an enterprise admin adds a custom developed enterprise app to the enterprise app store catalog maintained by the MAM module 104 of the EMM server 102. In this example, the enterprise app was developed through a contract that the sales department funded out of their budget and includes libraries that are licensed from a third party on a per use basis, meaning that the sales department must pay a fee to the third party for each and every installation of the enterprise app on devices 110. A maximum number of licenses is determined, e.g., based on a total cost that the sales department is willing to pay to the third party for licensing and the cost per license. Using aspects described herein, the admin defines the maximum number of licenses of the enterprise app, e.g., using the UIs 400 and 500. The license control functionality described herein ensures that once the number of installs of the enterprise app equals the maximum number of licenses of the enterprise app, no new users will have access to install the enterprise app (which would otherwise cause unplanned costs to the sales department). A particularly advantageous result of the license control functionality described herein is that the enterprise (e.g., the admin) need not specifically decide in advance every single user that will receive the enterprise app—instead, the admin can target a group of users that is larger than the maximum number of licenses of the enterprise app, and maintain control of the number of deployments of the app within that targeted group without deciding which specific users in the group obtain the app.

In another exemplary use case of the system and method of FIGS. 3-5, the enterprise has contracted with a third party app developer to create an enterprise app. The contract terms indicate that the enterprise has purchased 1000 licenses of the enterprise app, and that the enterprise pays additional fees to the third party app developer for each deployment beyond the 1000 maximum. The enterprise admin adds the enterprise app to the enterprise app store maintained by the MAM module 104 of the EMM server 102 and sets the maximum number of licenses to 1000 via UIs 400 and 500. The admin targets the app to any desired devices, users, or groups of users within the enterprise, and may use a first-come, first-served basis, reserved licenses, or a mixture of both, as described herein. In all instances, the license control functionality described herein ensures that the number of installations of the enterprise app never exceeds 1000, thereby advantageously helping to avoid unexpected contract violations and/or cost overruns.

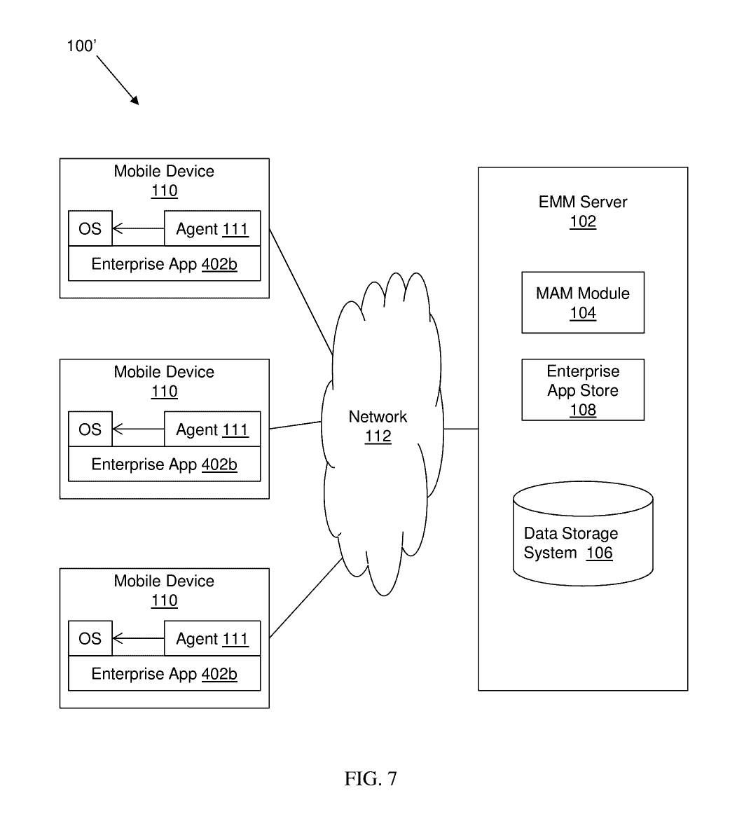

FIG. 7 shows an alternative implementation and use of the system 100′ in accordance with aspects of the invention. In the implementation described with respect to FIGS. 3-5, the MAM module 104 of the EMM server 102 manages distribution of an enterprise app by controlling (e.g., limiting) the ability of a device 110 to download the enterprise app from the app store 108 when the number of consumed licenses equals the maximum number of licenses. In the implementation described with respect to FIG. 7, any number of targeted users may download an enterprise app (e.g., enterprise app 402b) from the app store 108 onto their devices 110, and the MAM module 104 of the EMM server 102 manages concurrent uses of the app to not exceed the maximum number of licenses. As such, in the implementation described with respect to FIG. 7, the number of instances of the enterprise app installed on devices 110 may exceed the maximum number of licenses, but the number of simultaneous uses of the enterprise app on the devices 110 cannot exceed the maximum number of licenses.

In the implementation described with respect to FIG. 7, the admin may define properties of enterprise apps in a manner similar to that described with respect to FIGS. 4 and 5, e.g., using UI 400 and UI 500. For example, using the UI 500, an admin may define a maximum number of licenses for any given app, and may also view a number consumed licenses, available licenses, and details of which users/devices currently possess one of the consumed licenses. In the context of this embodiment, a consumed license corresponds to an instance of the app running on a device (i.e., an active session of the app on a device).

According to aspects of the invention, the MAM module 104 controls the number of simultaneous uses of an enterprise app by requiring each device 110 to request a license for the app when the device 110 attempts to use the app, e.g., when a user starts (i.e., initiates running) the app on the device 110. In embodiments, when a user of a device 110 starts the enterprise app (e.g., by tapping an icon of the app on a touch screen of the device is a conventional fashion), the agent 111 on the device 110 sends a message to the MAM module 104. The message may include a userID and/or deviceID associated with the device 110, a name of the enterprise app being started, and a request for a license for the enterprise app.

Upon receipt of the message from the device 110, the MAM module 104 determines whether the number of currently consumed licenses equals the maximum number of licenses for this app. On the one hand, when the number of consumed licenses is less than the maximum number of licenses for this app (i.e., there is an available license), the MAM module 104 sends a message to the agent 111 on the device 110, wherein the message causes the agent 111 to interact with the OS of the device 110 to permit the OS to run the app. The message may include a policy and a license associated with the app. The MAM module 104 also increments a count of consumed licenses for this app based on the sending a license to the device 110.

On the other hand, when the number of consumed licenses equals the maximum number of licenses for this app (i.e., there are no licenses available), the MAM module 104 sends a message to the agent 111 on the device 110, wherein the message causes the agent 111 to interact with the OS of the device 110 to prevent the OS from running the app. In this situation, the agent 111 may interact with the OS to cause the device 110 to display a notification that there are no licenses available and that the app cannot be opened/run.

Upon receiving the notification that there are no licenses available and that the app cannot be opened/run, the user may simply wait a period of time and try again later to open the app. This is because one or more licenses may subsequently become available when other users close (stop running) the same app on other devices 110. In embodiments, when a device 110 that possesses a license for the app closes the app (i.e., stops running the app on the device 110), the agent 111 on the device 110 sends a message to the MAM module 104. The message may include a userID and/or deviceID associated with the device 110, and a name of the enterprise app being closed. Upon receipt of this message, the MAM module 104 decrements the count of consumed licenses of the app, such that another user can now request and obtain the newly freed up license.

In another embodiment, upon receiving the notification that there are no licenses available and that the app cannot be opened/run, the user can respond to the notification by asking for a reservation. In embodiments, based upon user input at the device 110, the agent 111 sends a message to the MAM module 104 requesting a reservation for a license of the app. Upon receipt of the message from the device 110, the MAM module 104 adds the userID and/or device ID to a reservation queue for the app. When the license for the app subsequently becomes available (i.e. because the app was closed on another device), the MAM module 104 selects one of the users from the reservation queue and sends a message to the agent 111 on the device 110 associated with the selected user, wherein the message grants a license to the device 110 (e.g., causes the agent 111 to interact with the OS of the device 110 to permit the OS to run the app). The message to the device 110 of the selected user may also cause the agent 111 to interact with the OS to cause the device 110 to display a notification that a license has been granted and the app is now available to run.

In accordance with aspects described herein, the MAM module 104 may select a user from the reservation queue using any suitable selection criteria. In one embodiment, the MAM module 104 treats the reservation queue as a first-in-first-out queue, such that the user that has been waiting the longest time for a license is the selected user that receives the next available license. In another embodiment, each user may be assigned a pre-defined user priority, e.g., a ranking on a numerical scale, which the MAM module 104 uses in determining which user to select from the reservation queue for the next available license. For example, a first user may have a higher assigned ranking than a second user, such that the first user will be provided the next available license even though the second user has been waiting longer in the reservation queue.

In further aspects of the implementation described with respect to FIG. 7, the MAM module 104 may revoke a license from a device 110 that is currently running the app. For example, an admin may use the UI 500 (of FIG. 5) to select a user, and provide an input to revoke the license from the user. Based on this input, the MAM module 104 sends a message to the agent 111 on the device 110 of the selected user, wherein the message causes the agent 111 to interact with the OS to cause the OS to close (stop running) the app on the device 110. Upon closing the app, the agent 111 on the device 110 sends a message back to the MAM module 104 indicating that the app has been closed, and the MAM module 104 increments the count of available licenses for this app.

In accordance with additional aspects of the implementation described with respect to FIG. 7, the MAM module 104 may revoke a license from a lower priority user when the MAM module 104 receives a request for a license from a higher priority user and no licenses are currently available for the higher priority user. The user priorities may be similar to those described with respect to the reservation queue, e.g., assigned by the enterprise admin based on desired reasons for relative priority rankings of users within the enterprise.

In an exemplary scenario, a requesting user attempts to open the app on their device 110, which causes the agent 111 on the device to send a message to the MAM module 104 requesting a license for the app. In this example, the number of consumed licenses equals the maximum number of licenses, such that there are no licenses available for the requesting user. As described with respect to FIG. 5, the MAM module 104 may maintain a list of all users that currently have a license for any given app, and that list may include the priority ranking of each user that has a license of the app. Upon determining that there are no licenses available for the requesting user, the MAM module 104 compares the requesting user's priority to the respective priority of each user in the list of users that currently posses a license for the app. In embodiments, when the requesting user's priority is higher than that of a user that currently possesses a license, the MAM module 104 revokes the license from the lower priority user that currently possesses the license and grants the license to the higher priority requesting user. The MAM module 104 may send a message to the device of the lower priority user that currently possesses the license, wherein the message causes the agent 111 to interact with the OS to cause the device 110 to display a notification that the license for the app will be revoked at a specified time, e.g., in thirty minutes, or any other time that is predefined by the admin in the properties of the app.

In accordance with additional aspects of the implementation described with respect to FIG. 7, the system can be configured such that a user that is informed that their licenses is being revoked can be provided with the option to purchase a one-time use temporary license to continue using the app. This transaction can be handled using mobile payments inside the EMM server and providing a single-use license that does not count toward the count of currently used licenses. The cost of the single-use license may be defined by the admin, e.g., as a property of each enterprise app, and may be determined by any suitable measure.

Accordingly, the invention solves many problems and provides functionalities which can be implemented on a computing infrastructure as described further herein. For example, the systems and processes described herein allow the enterprise to assign a priority to users based on specific user, device type, or user group to grant a priority to a license of a particular application. As described herein, the respective user priorities may be used by the MAM module in determining which user to select from a reservation queue, and in determining to revoke a license from a lower priority user and grant that license to a higher priority user. The priorities may be based on device type, for example when it is critical that one type of device (e.g., an inventory scanner) have a higher priority than another type of device (e.g., a PDA).

The systems and processes described herein allow a policy to be set up to reserve specific licenses to targeted users. For example, as described herein, a subset of the maximum number of licenses may be reserved for a sub-group of the targeted users for an enterprise app. Reserved licenses may be used in both the distribution embodiment (FIGS. 3-5) and the concurrent use embodiment (FIG. 7).

The systems and processes described herein allow the assignment of a pool of licenses that may float from user to user based on active sessions. For example, consumed licenses may correspond to running instances (i.e., active sessions) of the app as described with respect to FIG. 7, and the maximum number of licenses may be available to all targeted users on a first-come, first-served basis.

The systems and processes described herein allow an administrator to revoke a license from a user for a specific device or for all of the user's devices. For example, a single user may have plural mobile devices registered with the enterprise, e.g., a smartphone, a tablet computer, and a laptop computer. The user may have the enterprise app installed on all their devices. In embodiments, when the admin can select the user in the UI 500 and revoke all the licenses from the user in one revoke input. The revoking may comprise uninstalling the app from all the user's devices, or closing the app on all the user devices. At another level of granularity, the UI 500 may display each device associated with a particular user, and the admin may provide input to revoke a license from a single device of a user while leaving a license unaffected on another device of the same user.

The systems and processes described herein allow the admin to immediately revoke a license from a device. For example, an admin may use UI 500 to revoke a license from a device listed in the UI 500. The revoking can be performed in both the distribution embodiment and the concurrent use embodiment.

The systems and processes described herein track how many simultaneous sessions are active to determine if the license is available. For example, as described herein, the agent on each device informs the MAM module when the app is initiated on a device and when the app is closed on a device, and using this information the MAM module maintains a count of number of running instances of the app across all devices. The MAM module may determine a number of available licenses based on the maximum number of licenses and the number of consumed licenses (number of running instances) of the app.

The systems and processes described herein provide policy settings allowing the administrator to set a time limit within an application if all the licenses are reserved. The user will receive a notification based on their priority of a time limit until the application is stopped and the license revoked.

The systems and processes described herein allow the administrator to set a reserve priority for a user or group. This priority is used to determine if they have the ability to initially reserve a license if all licenses are reserved.

The systems and processes described herein allow an administrator to set a running priority for a user group. This priority is used once the application has been started to determine the order in which users or groups are terminated in the event licenses are required.

The systems and processes described herein provide a reserve license of a user requesting to use the application. The reserve license should and preferably must be higher than a user's running priority that is currently using the application to steal the license of the running user.

The systems and processes described herein display a reservation time to the requester if the license will be revoked from a running user.

The systems and processes described herein allow the user to purchase a temporary single use license if none are available.

The systems and processes described herein allow a running user to purchase a temporary, single use license if their licenses are to be revoked and they wish to continue.

### Flow Diagrams

Any flow diagrams, sequence diagrams, sequence of steps, swim lane diagrams, block diagrams, etc. should be understood as representative of implementing processing steps of the invention which can be executed, for example, from either a server, in a client-server relationship, or they may run on a user workstation with operative information conveyed to the user workstation or a cloud environment. Furthermore, steps of the processes of the invention may be implemented using a computer readable storage medium having program code for use by or in connection with a computer or any instruction execution system. The software and/or computer program product can be implemented in the environments of FIGS. 1-7, e.g., configured or provisioned on a computer infrastructure as shown in FIG. 1 or can be in a cloud environment of FIG. 2 or can be a computer program product as further described below or any combinations thereof, including within the one of the systems of FIGS. 3 and 7, and aspects of the methods are described using reference numbers of elements from these systems. Moreover, the flow diagrams, sequence diagrams, sequence of steps, swim lane diagrams, block diagrams, etc. should be understood as illustrative of the architecture, functionality, and operation of possible implementations of systems, methods, and computer program products according to various embodiments of the present invention. The specific steps noted herein may occur out of the order noted, depending upon the functionality involved.

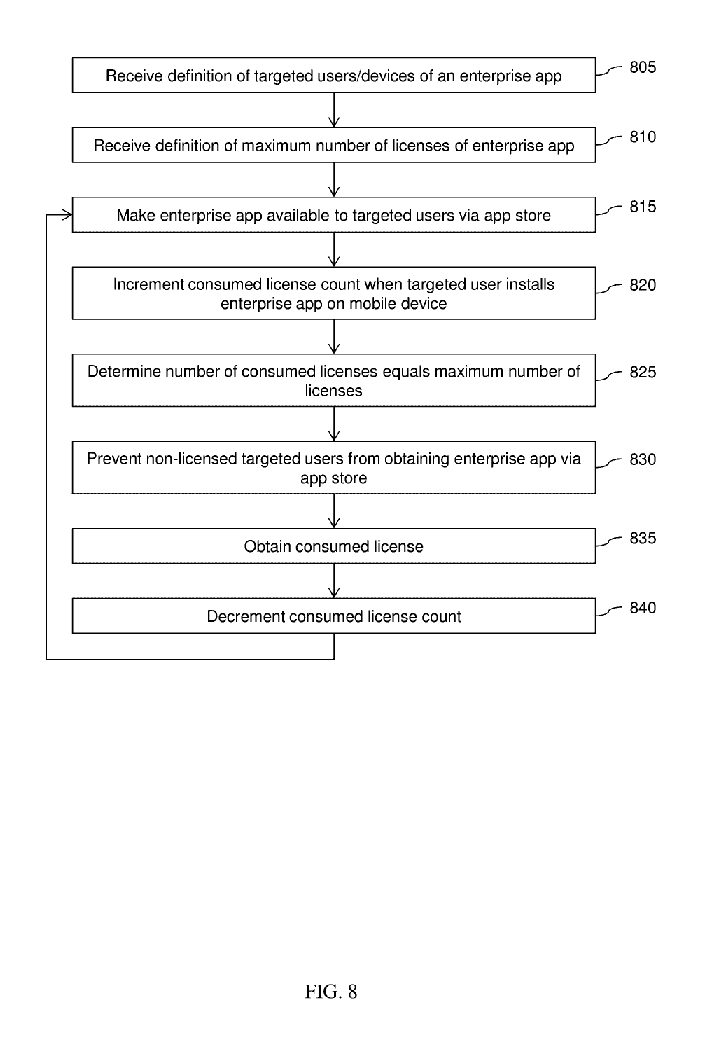

FIG. 8 shows a method in accordance with a first embodiment of the invention. At step 805, a system (e.g., system 100 comprising EMM server 102 running MAM module 104) receives a definition of targeted users for an enterprise app. Step 805 may comprise the system receiving input from an admin via an enterprise app management interface, such as UI 400, e.g., in a manner similar to that described with respect to FIG. 4.

At step 810, the system receives a definition of a maximum number of licenses for the enterprise app of step 805. Step 810 may comprise the system receiving input from an admin via an enterprise app management interface, such as UI 500, e.g., in a manner similar to that described with respect to FIG. 5.

At step 815, the system makes the enterprise app available to targeted users (defined at step 805) via an enterprise app store. For example, the system may publish the enterprise app to the app store in a manner such that only the targeted users can see the enterprise app in the app store, while non-targeted users cannot see the enterprise app in the app store, e.g., as described with respect to FIGS. 6A-D.

At step 820, the system increments a consumed license count for the enterprise app when a targeted user installs the enterprise app on their mobile device. For example, an agent on the user's mobile device sends a message to the system when the user installs the enterprise app on their mobile device. Based on the indication that the enterprise app has been installed on a mobile device, the system increments a consumed license counter, e.g., as described with respect to FIG. 5. Step 820 may be repeated until the number of consumed licenses equals the maximum number of licenses, e.g., any of the targeted users may install the enterprise app in their device(s) as long as the number of consumed licenses is less than the maximum number of licenses.

At step 825, the system determines the number of consumed licenses equals the maximum number of licenses. At step 830, based on the number of consumed licenses equaling the maximum number of licenses, the system prevents non-licensed targeted users from obtaining the enterprise app via the app store. For example, as described with respect to FIGS. 6A-D, the system may take action such that an icon that represents the app no longer appears in the app store for the non-licensed targeted users. In another example, as described with respect to FIGS. 6A-D, the system may take action such that a modified icon that represents the app is not available appears in the app store for the non-licensed targeted users. During this time when the number of consumed licenses equals the maximum number of licenses, licensed targeted users (i.e., users who currently have the enterprise app installed on their device) can still see the icon of the enterprise app in the app store.

At step 835, the system obtains a consumed license. In embodiments, the system may obtain a consumed license when a licensed user (i.e., a user who currently has the enterprise app installed on their device) voluntarily uninstalls the enterprise app from one or more of their devices. In this situation, the agent(s) on the one or more devices send a message to the system indicating the uninstall, and the system decrements the consumed license count at step 840 based on the number of licenses that were uninstalled. The process returns to step 815 after step 840 since the consumed license count has been decremented and is thus no longer equal to the maximum number of licenses.

In embodiments, the system may obtain a consumed license at step 835 when a license is revoked from a user. For example, as described with respect to FIGS. 3-5, an admin may revoke a license from a user, e.g., using UI 500. The revoking by the admin causes the agent(s) on the one or more devices to force uninstall the enterprise app from the device(s). In this situation, the agent(s) on the one or more devices send a message to the system indicating the uninstall, and the system decrements the consumed license count at step 840 based on the number of licenses that were uninstalled. The process returns to step 815 after step 840 since the consumed license count has been decremented and is thus no longer equal to the maximum number of licenses.

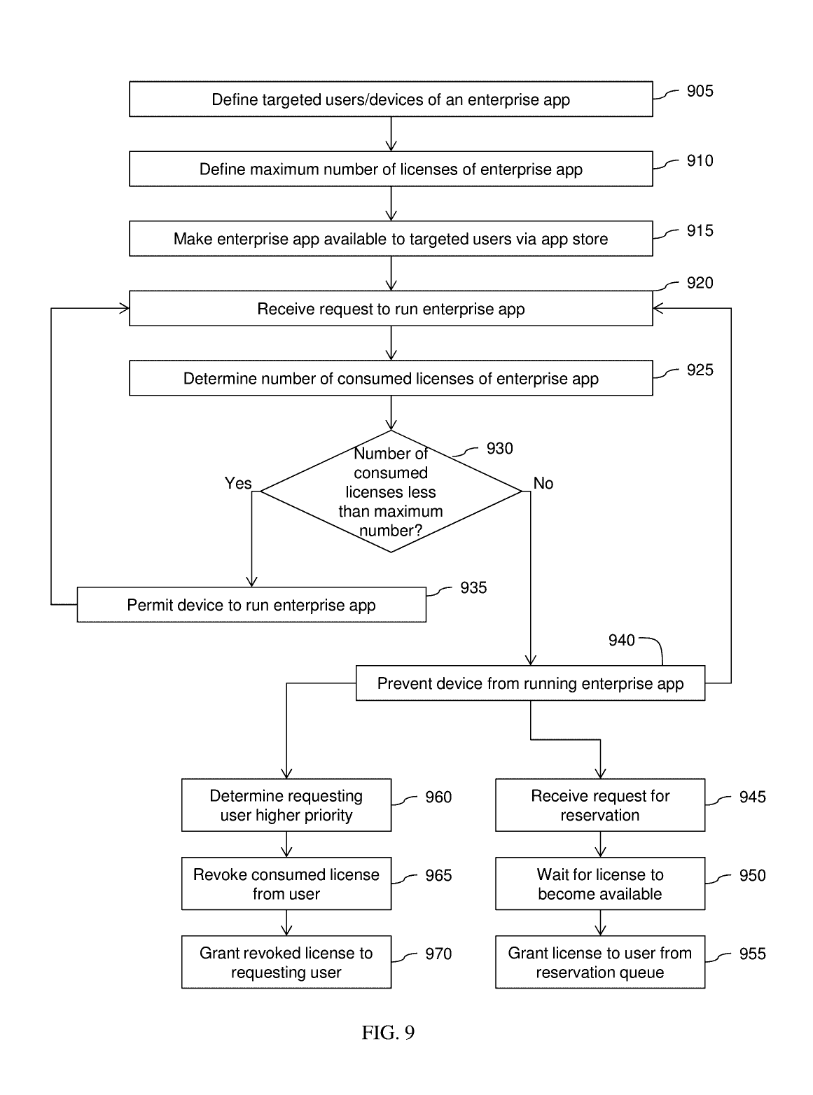

FIG. 9 shows a method in accordance with a second embodiment of the invention. At step 905, a system (e.g., system 100′ comprising EMM server 102 running MAM module 104) receives a definition of targeted users for an enterprise app. Step 905 may comprise the system receiving input from an admin via an enterprise app management interface, such as UI 400, e.g., in a manner similar to that described with respect to FIG. 4.

At step 910, the system receives a definition of a maximum number of licenses for the enterprise app of step 905. Step 910 may comprise the system receiving input from an admin via an enterprise app management interface, such as UI 500, e.g., in a manner similar to that described with respect to FIG. 5.

At step 915, the system makes the enterprise app available to targeted users (defined at step 805) via an enterprise app store. For example, the system may publish the enterprise app to the app store in a manner such that only the targeted users can see the enterprise app in the app store, while non-targeted users cannot see the enterprise app in the app store. In the embodiment of FIG. 9, distribution of the enterprise app is not limited at the app store level, and the enterprise app may be installed on any number of mobile devices registered with the enterprise.

At step 920, the system receives a request from a mobile device to run the enterprise app on the mobile device. In embodiments, when the user attempts to open/run the enterprise app on their mobile device 110, an agent 111 on the mobile device sends a message to the MAM module 104, as described with respect to FIG. 7. The message includes a request to run the enterprise app.

At step 925, the system determines the number of consumed licenses. In embodiments, the system maintains a counter of consumed licenses, the value of the counter being equal to the number of concurrent active sessions of the enterprise app across all mobile devices in the enterprise. The system also stores the user defined value of maximum number of licenses that was designated at step 910, e.g., as shown in UI 500. When the system receives a new request to run the app, as at step 920, the system compares the number of consumed licenses to the maximum number of licenses.

When, at step 930, the number of consumed licenses is less than the maximum number of licenses, this indicates that a license is available for the requesting user, and then at step 935 the system permits the mobile device of the requesting user to run the enterprise app. This may be performed in the manner described with respect to FIG. 7, e.g., by the MAM module 104 sending a message to the agent 111 on the device 110, wherein the message causes the agent 111 to interact with the OS of the device 110 to permit the OS to run the enterprise app. Step 935 may also include the system incrementing the counter of consumed licenses for this enterprise app.

When, at step 930, the number of consumed licenses is not less than the maximum number of licenses, this indicates that no licenses are available for the requesting user, and then at step 940 the system prevents the mobile device of the requesting user from running the enterprise app. This may be performed in the manner described with respect to FIG. 7, e.g., by the MAM module 104 sending a message to the agent 111 on the device 110, wherein the message causes the agent 111 to interact with the OS of the device 110 to prevent the OS from running the enterprise app. In this situation, the agent 111 may interact with the OS to cause the device 110 to display a notification that there are no licenses available and that the app cannot be opened/run.

One possible action after the denial of running the enterprise app at step 940 is that the requesting user may wait and try to open the app at a later time. This is indicated the arrow returning to step 920.

Another alternative action after the denial of running the enterprise app at step 940 is that the requesting user can request a reservation for the enterprise app. For example, as described with respect to FIG. 7, at step 945 the system may receive a reservation request from the agent on the mobile device of the requesting user. Step 945 may include the system placing the requesting user in a reservation queue, as described with respect to FIG. 7. At step 950, the system waits until a license for the enterprise app becomes available, either by a user voluntarily closing the enterprise app in their device or by a revoke (i.e., the system forcing a mobile device to close the enterprise app), as described with respect to FIG. 7. At step 955, when a license becomes available, the system selects a user from the reservation queue and grants the newly available license to the selected user. The system may select the user from the reservation queue based on respective priorities that are based on at least one of user, device type, user group.

Another alternative action after the denial of running the enterprise app at step 940 is that the system immediately initiates the process to revoke a license from a current user for the purpose of granting the license to the requesting user. At step 960, the system determines that the requesting user has a higher priority than a current user of the enterprise app, e.g., as described with respect to FIG. 7. At step 965, the system automatically revokes the license from the lower priority user that currently possesses the license, and at step 970 the system automatically grants the license to the higher priority requesting user. The revoking may be performed in the manner described herein, e.g., the system sending instruction to the agent on the mobile device of the lower priority user to force close the enterprise app, the system receiving a message from that agent that the enterprise app is now closed, and the system sending instruction to the agent on the mobile device of the higher priority user to open the enterprise app.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing examples have been provided for the purpose of explanation and should not be construed as limiting the present invention. While the present invention has been described with reference to an exemplary embodiment, changes may be made, within the purview of the appended claims, without departing from the scope and spirit of the present invention in its aspects. Also, although the present invention has been described herein with reference to particular materials and embodiments, the present invention is not intended to be limited to the particulars disclosed herein; rather, the present invention extends to all functionally equivalent structures, methods and uses, such as are within the scope of the appended claims.

What is claimed:

1. A method implemented in a computer infrastructure having computer executable code tangibly embodied on a computer readable storage medium having programming instructions operable to:
make an enterprise app available to targeted users via an enterprise app store;
determine a number of consumed licenses equals a maximum number of licenses for the enterprise app; and
based on the determining, preventing non-licensed ones of the targeted users from obtaining the enterprise app from the enterprise app store while simultaneously permitting licensed ones of the targeted users to access the enterprise app in the enterprise app store.

2. The method of claim 1, further comprising receiving user input defining the targeted users, wherein the user input is received via a user interface of a server.

3. The method of claim 1, further comprising receiving user input defining the maximum number of licenses, wherein the user input is received via a user interface of a server.

4. The method of claim 1, wherein the preventing the non-licensed ones of the targeted users from obtaining the enterprise app from the enterprise app store comprises one of:
causing an icon of the enterprise app to not appear in the enterprise app store for the non-licensed ones of the targeted users; and
causing a modified icon of the enterprise app to appear in the enterprise app store for the non-licensed ones of the targeted users.

5. The method of claim 4, further comprising:
obtaining a previously consumed license of the enterprise app; and
re-making the enterprise app available in the enterprise app store to the non-licensed ones of the targeted users.

6. The method of claim 5, wherein the obtaining comprises one of:
receiving a message from an agent on a mobile device of one of the licensed ones of the targeted users, wherein the message indicates that the enterprise app has been uninstalled from the mobile device; and
sending an instruction to the agent on the mobile device, wherein the instruction causes the agent to interact with the operating system of the mobile device to force uninstall the enterprise app from the mobile device.

7. The method of claim 1, further comprising receiving user input defining a number of reserved licenses of the enterprise app, and wherein:
the number of reserved licenses are reserved for at least one device, user, or group of users; and
a number of first-come, first-served licenses, that is equal to the maximum number of licenses less the number of reserved licenses, is made available to the targeted users on a first-come, first-served basis.

8. A computer program product comprising a computer readable storage medium having program instructions embodied therewith, the program instructions being executable by a server to cause the server to:
publish an enterprise app to an enterprise app store such that it is available for download by targeted users;
receive a request from a mobile device to run the enterprise app;
determine whether a number of consumed licenses of the enterprise app is less than a maximum number of licenses of the enterprise app; and
based on the determining, perform one of: permit the mobile device to run the enterprise app when the number of consumed licenses is less than the maximum number of licenses; and prevent the mobile device from running the enterprise app when the number of consumed licenses is not less than the maximum number of licenses.

9. The computer program product of claim 8, wherein the program instructions further cause the server to receive user input, via a user interface, defining the targeted users for the enterprise app.

10. The computer program product of claim 8, wherein the program instructions further cause the server to receive user input, via a user interface, defining the maximum number of licenses of the enterprise app.

11. The computer program product of claim 8, wherein the request is received from an agent on the mobile device, the agent being a separate program from the enterprise app and configured to interact with an operating system (OS) of the mobile device via at least one Application Programming Interface (API).

12. The computer program product of claim 11, wherein the permitting the mobile device to run the enterprise app comprises sending an instruction to the agent to cause the OS to run the enterprise app.

13. The computer program product of claim 11, wherein the preventing the mobile device from running the enterprise app comprises sending an instruction to the agent to cause the OS to not run the enterprise app.

14. The computer program product of claim 8, wherein the program instructions further cause the server to:
based on the preventing the mobile device from running the enterprise app, place a user associated with the mobile device in a reservation queue;
receive an indication that another mobile device has stopped running the enterprise app;
select a user from the reservation queue based on a pre-defined priority; and
permit a mobile device of the selected user to run the enterprise app.

15. The computer program product of claim 8, wherein the program instructions further cause the server to:
based on the preventing the mobile device from running the enterprise app, force another mobile device to stop running the enterprise application; and
based on the forcing the other mobile device to stop running the enterprise application, permit the mobile device to run the enterprise app.

16. The computer program product of claim 15, wherein the forcing the other mobile device to stop running the enterprise app comprises the server sending instruction to an agent on the other mobile device to cause the operating system of the other mobile device to close the enterprise app.

17. The computer program product of claim 16, wherein the instructions cause the other mobile device to display a message that the enterprise app will be force closed in a predefined amount of time.

18. A system, comprising:
a CPU, a computer readable memory and a computer readable storage medium;
program instructions to cause a server to receive a request from an agent on a mobile device to run a enterprise app; and
program instructions to cause the server to send instruction to the agent to one of: permit the mobile device to run the enterprise app when a number of consumed licenses of the enterprise app is less than a maximum number of licenses of the enterprise app; and prevent the mobile device from running the enterprise app when the number of consumed licenses is not less than the maximum number of licenses,
wherein the program instructions are stored on the computer readable storage medium for execution by the CPU via the computer readable memory.

19. The system of claim 18, wherein:
the enterprise app is installed on the mobile device;
the agent is on the mobile device and is separate from the enterprise app; and
the agent interacts with an operating system (OS) of the mobile device via at least one Application Programming Interface (API) to cause one of the permitting and the preventing.

20. The system of claim 18, wherein:
based on the preventing the mobile device from running the enterprise app, the server forces another mobile device to stop running the enterprise application; and
based on the forcing the other mobile device to stop running the enterprise application, the server permits the mobile device to run the enterprise app.
